(19) United States
(12) Patent Application Publication
(10) Pub. No.: US 2005/0188142 A1
(43) Pub. Date: Aug. 25, 2005

(54) Information processing apparatus and method

(75) Inventor: Kenji Nakajima, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/997,416

(22) Filed: Nov. 24, 2004

(30) Foreign Application Priority Data
Feb. 23, 2004 (JP) 2004-045864

(51) Int. Cl. G06F 13/00

(52) U.S. Cl. 710/303

(57) ABSTRACT

An information processing apparatus is provided with an LCD display, an MO drive and a memory card slot, with a main processor putting the USB bridge subprocessor into an active state to cause the USB bridge subprocessor to execute input/output processing from/to a host when the main processor judges the host to be connected, and putting the USB bridge subprocessor into an inactive state to cause the information processing apparatus to execute a standalone operation when the main processor judges a processing request from an operation unit to be present. The main processor pulls up a specific signal line connecting the USB bridge subprocessor and the host to put the USB bridge subprocessor into an active state.

This application is a priority based on prior application No. JP 2004-045864, filed Feb. 23, 2004, in Japan.

### BACKGROUND OF THE INVENTION

1. Field of the Invention

The present invention relates generally to an information processing apparatus provided with processing capabilities as a peripheral device for a host such as a personal computer and processing capabilities to handle data processing and display on a standalone basis and method thereof, and, more particularly, to an information processing apparatus and method for implementing peripheral device capabilities and standalone capabilities using a multiprocessor configuration.

2. Description of the Related Arts

MO, HDD and other peripheral devices—devices used by a plug-in connection to a host such as a personal computer—have hitherto used an interface control LSI for host connection as a processor (CPU), implementing external storage and other peripheral device capabilities with a single processor. On the other hand, a composite apparatus under consideration in recent years is provided, in addition to the capabilities of the peripheral device such as external storage, with the standalone operation capabilities including writing captured images stored in an electronic still camera's memory card to an MO and displaying image data in a memory card or MO on the display unit of the apparatus or on an external TV device, without being dependent on host applications (see, e.g., Japanese Patent Application Laid-Open Publication Nos. 1998-083366 and 1996-161178, and Japanese Utility Model Registration Laid-Open No. 3094734).

Incidentally, to realize a composite apparatus provided with standalone capabilities in a conventional plug-in type peripheral device, the processor on board the host interface control LSI is employed to implement the standalone capabilities. The processor on board the interface control LSI, however, is relatively low in processing performance and has difficulties in sufficiently handling complex image processing tasks such as compressing/decompressing image data required of the apparatus standalone capabilities. For this reason, although able to meet the requirements as a peripheral device of a host, the composite apparatus offers a poor user interface during a standalone operation and cannot fully satisfy the operational requirements, resulting in an odd piece of merchandise. Further, the standalone capabilities are locked (blocked) in conventional composite apparatuses so as to be kept disabled during host connection, allowing the apparatuses to function merely as peripheral devices subordinate to the host. On the other hand, the apparatuses cannot function as devices connected to the host if the standalone capabilities are active. This enables the apparatuses to operate only in one operation mode despite being equipped with two—one to function as a peripheral device such as external storage and the other to operate on a standalone basis, thus preventing the apparatuses from fully delivering the convenience as composite apparatuses.

### SUMMARY OF THE INVENTION

According to the present invention there are provided an information processing apparatus and method that offer the full performance and capabilities in both the host connection and standalone operation modes. The information processing apparatus of the present invention comprises a subprocessor (sub-CPU) that is operable to execute input/output processing from/to an upper-level apparatus; and a main processor (main CPU) that is operable to disable a standalone operation so as to put the subprocessor into an active state when judging the upper-level apparatus to be connected, the main processor putting the subprocessor into an inactive state to allow the information processing apparatus to execute the standalone operation when judging an instruction request from an operation unit to be present.

The subprocessor executes, as the input/output processing from/to the upper-level apparatus, data transfer to write data to or read data from a storage unit based on a command from the upper-level apparatus, and the main processor executes, as the standalone operation of the information processing apparatus, tasks such as data transfer between different storage units, data transfer from the storage unit to a display unit and expansion of compressed image data for display on the display unit. The main processor pulls up a specific signal line connecting the subprocessor and the upper-level apparatus to put the subprocessor into an active state, and pulls down the specific signal line to put the subprocessor into an inactive state. The main processor turns on power supply to the subprocessor to put the subprocessor into an active state, and turns off the power supply to put the subprocessor into an inactive state. The main processor may turn off a reset signal to the subprocessor to put the subprocessor 34a into an active state, and turn on the reset signal to put the subprocessor into an inactive state. The main processor puts the subprocessor into an active state when recognizing the connection to the upper-level apparatus at the startup by power-up of the information processing apparatus, whereas the main processor puts the subprocessor into an inactive state to enable the standalone operation until recognizing the connection when recognizing the non-connection to the upper-level apparatus. At the startup by power-up of the information processing apparatus, the main processor selects, based on user-set information, whether to put the subprocessor into an active state or render the subprocessor inactive to enable the standalone operation. When judging a standalone operation instruction from the operation unit to be present at the startup by power-up of the information processing apparatus, the main processor renders the subprocessor inactive to enable the standalone operation, whereas when judging the standalone operation instruction to be absent at the startup by power-up of the information processing apparatus, the main processor puts the subprocessor into an active state. When judging both a processing request from the upper-level apparatus and a processing request from the operation unit to be present, the main processor controls the subprocessor to switch between active and inactive states so as to alternately execute the processing requests from the upper-level apparatus and the operation unit through time sharing or sharing on a command-by-command basis. At the time of alternately executing the processing request from the upper-level apparatus and the processing request from the operation unit, the main processor, while executing one of the processing requests, transfers data to a data buffer for the other processing request suspended. In the information processing apparatus of the present invention, when further comprising a plurality of the subprocessors each operable to individually connect a plurality of the upper-level apparatuses, the main processor controls the individual subprocessors to switch between active and inactive states so as to allow the plurality of the subprocessors to execute processing requests from the plurality of the upper-level apparatuses through time sharing or sharing on a command-by-command basis.

The present invention provides an information processing method of a main processor executing a standalone operation of an information processing apparatus while at the same time monitoring a subprocessor that executes input/output processing from/to an upper-level apparatus. The information processing method of the main processor comprises:
when the upper-level apparatus is judged to be connected thereto, disabling the standalone operation and putting the subprocessor into an active state to allow the subprocessor to execute the input/output processing from/to the upper-level apparatus; and
when a processing request from an operation unit is judged to be present, putting the subprocessor into an inactive state to allow the information processing apparatus to perform the standalone operation. The details of the information processing method of the present invention are essentially the same as those of the information processing apparatus of the present invention.

In the present invention, two processors are provided, a subprocessor for executing input/output processing from/to the upper-level apparatus in the upper-level connection mode and a main processor for executing standalone processings in the standalone operation mode, allowing dynamic switching between the upper-level connection and standalone operation modes to handle necessary processings without keeping the information processing apparatus locked to a specific mode, thanks to the main processor controlling the operation status of the subprocessor as necessary. Since the specially designed main processor handles the processings in the standalone mode, complex processings are possible including data transfer between different storage devices such as an MO and a memory card and decompressing and displaying compressed image data read from a storage device. This allows realizing the full performance and capabilities in both the host connection and standalone operation modes. Moreover, when one instructs the display of images from the memory card through switch operations during input/output processing from/to the upper-level apparatus, the processings in two modes can be performed at the same time—the processings in the upper-level connection mode by the subprocessor and those in the standalone operation mode by the main processor—through time sharing or sharing on a command-by-command-basis. This allows the information processing apparatus to function on a standalone basis while in use as a peripheral device of the upper-level apparatus, ensuring considerably improved convenience as the composite apparatus. Further, the main processor can individually control the operating condition of a plurality of subprocessors provided to suit different interface types such as USB, IEEE1394 and wireless, executing input/output processing from/to a plurality of upper-level apparatuses through time-sharing or command-by-command sharing of the plurality of subprocessors and implementing the processings as a peripheral device through a multihost connection. The above and other objects, features and advantages of the present invention will become more apparent from the following detailed description with reference to the drawings.

### BRIEF DESCRIPTION OF THE DRAWINGS

FIG. 1 is an explanatory view of an information processing apparatus of the present invention and uses thereof;

FIGS. 2A and 2B are plan and front views of the information processing apparatus of the present invention;

FIGS. 3A and 3B are left and right side views of the information processing apparatus of the present invention;

FIG. 4 is a block diagram showing an embodiment of a functional configuration of the information processing apparatus of the present invention;

FIGS. 5A and 5B are a flowchart of control processings by a main processor in FIG. 4 that start up with the priority to a host connection mode;

FIG. 6 is a flowchart of control processings by a subprocessor in FIG. 4;

FIGS. 7A and 7B are a flowchart of control processings by the main processor in FIG. 4 that start up in a user-selected mode;

FIGS. 8A and 8B are a flowchart of control processings by the main processor in FIG. 4 that start up with the priority to a standalone operation mode;

FIG. 9 is a block diagram showing other embodiment of the present invention for controlling the operating condition of a plurality of interface control subprocessors by turning power on/off;

FIG. 10 is a block diagram showing other embodiment of the present invention for controlling the operating condition of the plurality of the interface control subprocessors with reset signals; and

FIG. 11 is a block diagram showing other embodiment of the present invention having a multi-host connection configuration with a host connected to each of the plurality of the interface control subprocessors.

### DETAILED DESCRIPTION OF THE PREFERRED EMBODIMENT

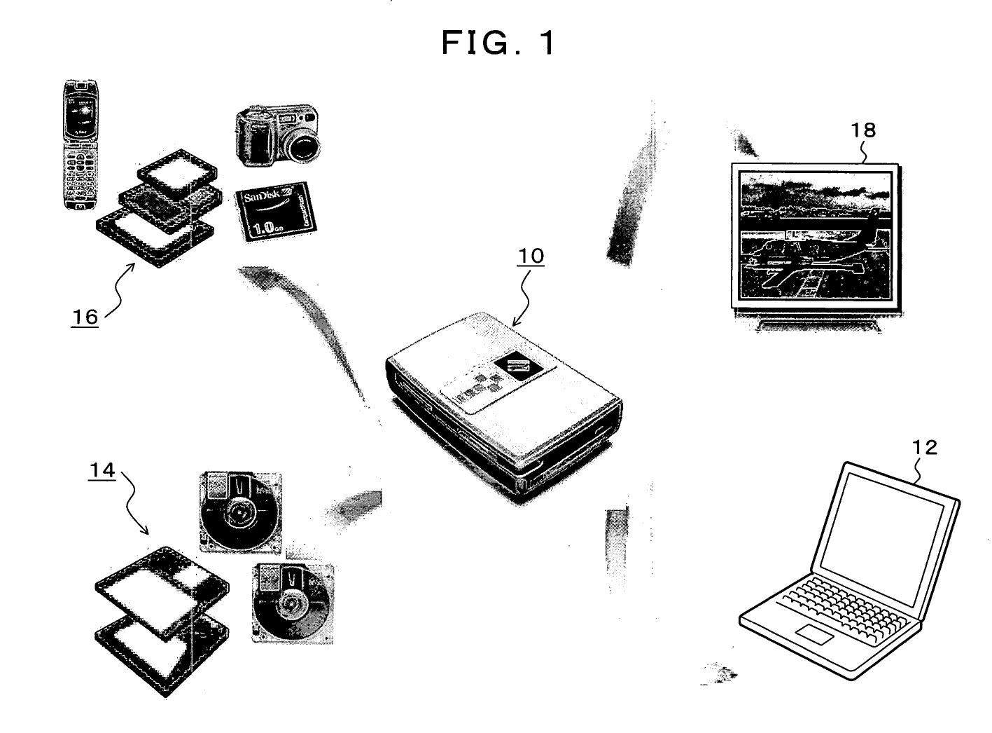

FIG. 1 is an explanatory view of an information processing apparatus of the present invention and uses thereof. In FIG. 1, an information processing apparatus 10 of the present invention can be connected to a host 12 such as a personal computer, an upper-level apparatus, for use as an external storage or other peripheral device. The information processing apparatus 10 of the present invention can also be employed as a standalone apparatus disconnected from the host 12. In the present embodiment, the information processing apparatus 10 of the present invention has the capability to handle MO cartridges 14 and memory cards 16 storing image data of a mobile phone terminal or electronic still camera and, as will become clear in the description that follows, has a LCD display therein and is externally connectable with a TV device 18. Therefore, when used as a peripheral device connected to the host 12, the information processing apparatus 10 can write to or read from the MO cartridge 14 or the memory card 16 by a command from the host 12. As for the standalone operation, on the other hand, the information processing apparatus 10 can read image data stored in the MO cartridge 14 or the memory card 16 to transfer the data between the MO cartridge 14 and the memory card 16 and display an image on the LCD display of the apparatus or the external TV device 18.

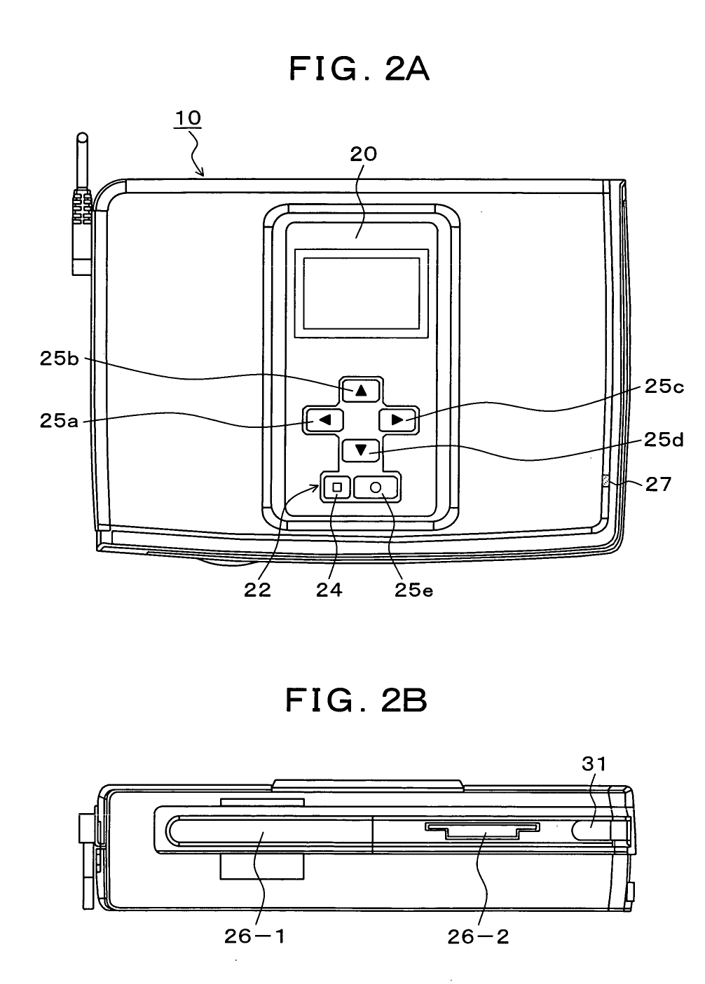

FIGS. 2A and 2B are plan and front views of the information processing apparatus 10 of the present invention. As is apparent from the plan view of FIG. 2A, a LCD display 20 is provided at the upper center of the information processing apparatus 10, with an operation unit 22 and an LED 27 provided therebelow. The operation unit 22 is provided with a confirm button 25e, direction keys 25a to 25d arranged in the four directions and a cancel button 25e. The standalone operation can be performed with the direction keys 25a to 25d, the confirm button 24e and the cancel button 25e of the operation unit 22 and by selecting menu items in the initial screen displayed on the LCD display 20. When viewed from the front view of FIG. 2B, the information processing apparatus 10 is provided with a Compact Flash (R) card slot 26-1, a memory card slot 26-2 for use as a slot for SD Card, Memory Stick and SmartMedia and a remote control light receiving unit 31.

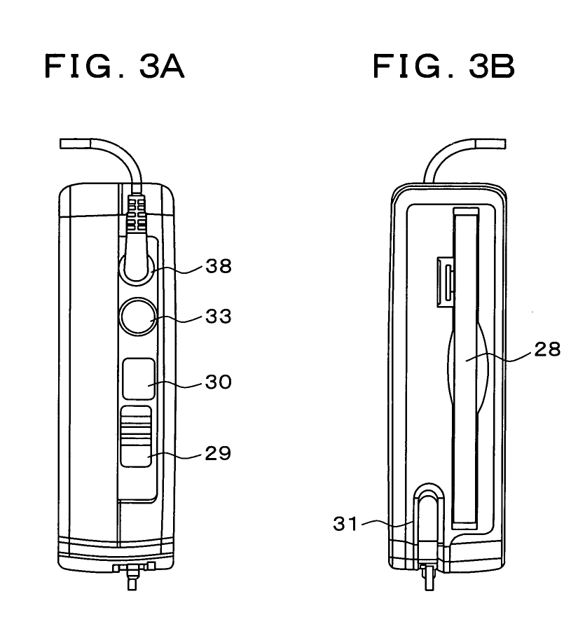

FIGS. 3A and 3B are left and right side views of the information processing apparatus 10 of the present invention, with a power switch 29, a USB connector 30, a TV connector 33 and a power connector (DC jack) 38 provided on the left side shown in FIG. 3A and an MO slot 28 and a remote control light receiving unit 31 provided on the right side.

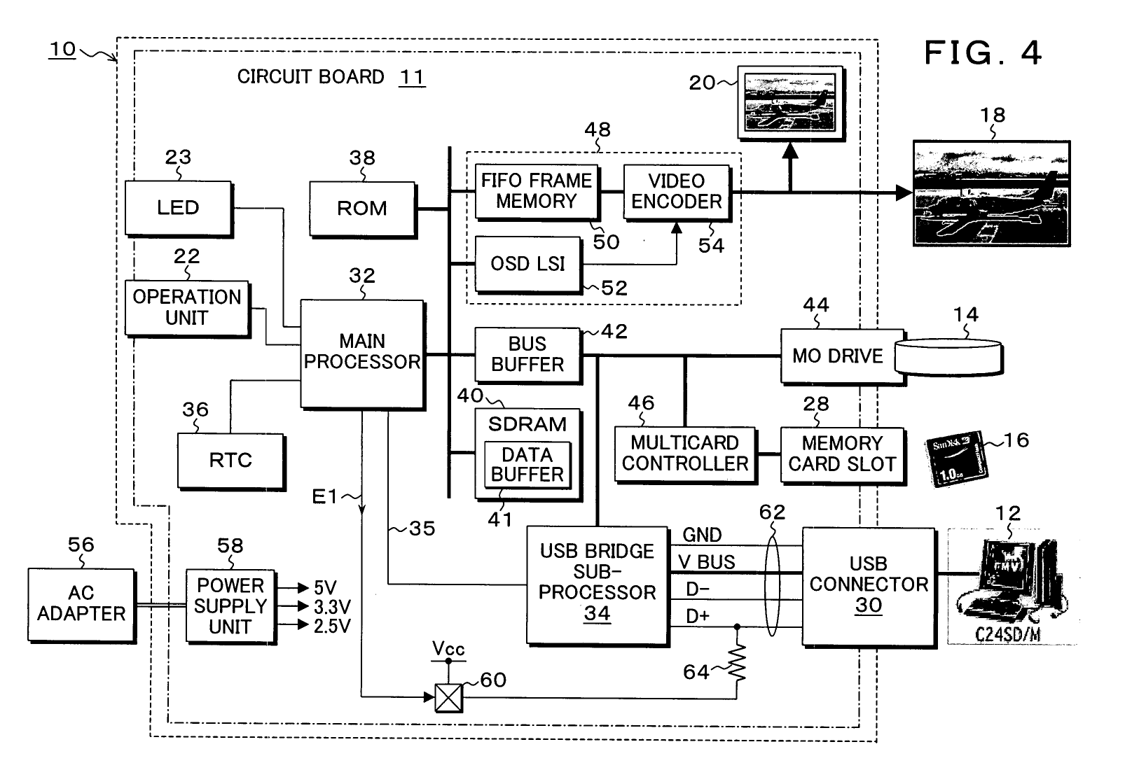

FIG. 4 is a block diagram showing an embodiment of the functional configuration of the information processing apparatus 10 of the present invention. In FIG. 4, a circuit board 11 of the information processing apparatus 10 of the present invention is provided in the present embodiment with a USB bridge subprocessor 34 as the subprocessor to execute input/output processing from/to the host 12. The USB bridge subprocessor 34 is more specifically realized with a USB bridge LSI. The circuit board 11 is also provided with a main processor 32 for executing the data transfer and the image display in the standalone operation. The main processor 32 manages the apparatus as a whole including the USB bridge subprocessor 34, monitoring the processing and operation status of each device and selectively controlling the input/output from/to the host 12 and the standalone processings as necessary. The USB bridge subprocessor 34 is connected to the USB connector 30 with a USB bus 62, whereas the host 12 is connected to the USB connector 30 with a cable. The host 12 may be connected to the USB connector 30 before the information processing apparatus 10 is put into use or while the apparatus 10 is operating. An MO drive 44 and the memory card slot 28 are provided as storage devices of the information processing apparatus 10. The MO drive 44 can be written to and read from when the MO cartridge 14 is attached. As for the memory card slot 28, data can be written to and read from the memory card 16 under the control of a multicard controller 46 when the memory card 16 is inserted. The MO drive 44 and the multicard controller 46 are connected to the bus of the main processor 32 via a bus buffer 42. A ROM 38 and an SDRAM 40 are provided in the bus of the main processor 32. The ROM 38 has programs—those to be executed by the main processor 32—stored in advance. The SDRAM 40 is used as a memory area for the main processor 32 to execute the expansion (decoding) of compressed image data stored in the MO cartridge 14 or the memory card 16. Further, in the present invention, an area is secured in the SDRAM 40 as a data buffer 41, with the data buffer 41 used as the data buffer for the inactive processing side as when the standalone operation by the main processor 32 and the input/output processing from/to the host 12 by the USB bridge subprocessor 34 are performed through time sharing. The main processor 32 is connected to the operation unit 22, an LED 23 and further a real-time clock 36. On the other hand, a power supply unit 58 is provided in the circuit board 11, receiving an AC input from an external AC adapter 56 and supplying necessary power, 5 VDC, 3.3 VDC and 2.5 VDC, to the various portions of the circuit board 11. Further, an LCD controller 48 is provided for the bus of the main processor 32. The LCD controller 48 is provided, in the present embodiment, with a FIFO frame memory 50, an OSD (On Screen Display) LSI 52 and a video encoder 54, with the output of the video encoder 54 connected to the LCD display 20 provided in the apparatus itself and connectable to the external TV device 18 as well. The main processor 32 and the USB bridge subprocessor 34 are connected with a control line 35, exchanging processing requests and responses. The main processor 32 also has the capabilities to put the input/output processing of the host 12 from/to the USB bridge subprocessor 34 into an active state when judging the upper-level apparatus 12 to be connected to the USB connector 30 and, when judging, under this condition, a standalone operation processing request—a request made through switch operations on the operation unit 22—to be present, puts the input/output processing of the USB bridge subprocessor 34 from/to the host 12 into an inactive state, thus allowing the apparatus to function on a standalone basis. To control the operating condition of the USB bridge subprocessor 34 with the main processor 32, a data signal line D+ of the USB bus 62 is connected to a power source Vcc via a pull-up resistor 64 and an FET switch 60 in the present embodiment. Controlling the FET switch 60 on and off with the main processor 32 switches the voltage condition of the data signal line D+ between pull-up and pull-down states. Here, in the USB interface, the data signal line D+ must be pulled up to allow the detection of a USB device connection to the host 12. In the present embodiment, for this reason, to render active the input/output processing by the host 12, the main processor 32 turns on the FET switch 60 and applies the supply voltage Vcc to the data signal line D+ via the pull-up resistor 64 to pull up the data signal line D+, thus allowing the host 12, connected with a cable via the USB connector 30, to detect the connection of the information processing apparatus 10 of the present invention and causing the host 12 to make an input/output request to the information processing apparatus 10. More specifically, a command is issued to the USB bridge subprocessor 34 to make this request. When turning on the FET switch 60 to pull up the data signal line D+, the main processor 32 disables the standalone operation based on switch operations on the operation unit 22. On the other hand, when the host 12 is not connected, the main processor 32 turns off the FET switch 60 to pull down the data signal line D+ of the USB bus 62. In this case, the main processor 32 performs only the standalone operation based on switch operations on the operation unit 22. Further, in the present invention, the input/output processing of the host 12 from/to the USB bridge subprocessor 34 based on the issuance of a command is alternated with the standalone operation by the main processor 32 based on switch operations from the operation unit 22, for example, through sharing on a command-by-command basis or in steps of a given data size, e.g., on a frame data-by-frame data basis. This allows simultaneous performance of the input/output processing and the standalone operation. One of the following three modes can be selected for the host's input/output processing and the standalone operation depending on which of the two is given priority.
(1) Priority to the host connection mode
(2) Priority to the standalone operation mode
(3) Priority to the user selection
   In the case of the priority to the host connection mode, for example, when judging the host 12 to be connected to the USB connector 30 at the power-up of the information processing apparatus 10, the main processor 32 turns on the FET switch 60 to pull up the data signal line D+, rendering active the input/output processing by a command from the host 12. When judging, after the startup with the priority to the host connection mode, that a standalone operation request has been made by switch operations on the operation unit 22 with no input/output request from the host 12, the main processor 32 turns off the FET switch 60 to pull down the data signal line 64, thus disconnecting the information processing apparatus 10 as a USB device from the host 12, i.e., rendering the information processing apparatus 10 inactive, and thus executing the standalone operation. At the completion of the standalone operation, the main processor 32 turns on the FET switch 60 to pull up the data signal line D+ and returns to the host connection mode. In the case of the priority to the standalone operation mode, on the other hand, the main processor 32 checks for a processing request by switch operations on the operation unit 22, with the FET switch 60 turned off at the power-up of the information processing apparatus 10 and the information processing apparatus 10 as a USB device disconnected from the host 12, executing the standalone operation corresponding to the processing request—in the presence of any such request. At the completion of the standalone operation, the main processor 32 turns on the FET switch 60, allowing the host 12 to detect the connection of the information processing apparatus 10 as a USB device and enabling the input/output processing by the issuance of a command from the host 12. Further, in the case of the priority to the user selection, the user selects the priority to the host connection mode or to the standalone operation mode in advance at the time of the startup. This allows the processing or operation to be performed in response to this user selection at the power-up. Here, the data flow in individual modes—host connection mode, standalone operation mode and further simultaneous host connection and standalone operation mode—can be described as follows. First, in the host connection mode, when the command from the host 12 is a write command, the write data is received by the USB bridge subprocessor 34 from the USB connector 30 and written to the MO slot 28 via the MO drive 44 or the multicard controller 46. When the command from the host 12 is a read command, data in the MO cartridge 14 or the memory card 16 is transferred to the host 12 via the USB bridge subprocessor 34 and the USB connector 30 as a result of the read operation to the MO drive 44 or the multicard controller 46 and the memory card slot 28. In the standalone operation, on the other hand, data is transferred between the MO cartridge 14 and the memory card 16, and image data is read from the MO cartridge 14 or the memory card 16 for display on the LCD display 20 or on the external TV device 18. Taking, for example, the reading and display of image data in the MO cartridge 14, the image data is, for example, stored in a compressed manner in the MO cartridge 14, and the main processor 32 reads the image data from the MO cartridge 14 based on a read command from the MO drive 44 by switch operations on the operation unit 22 and unarchives the data in the data buffer 41 of the SDRAM 40 via the bus buffer 42. The main processor 32 proceeds with the expansion of the compressed image data unarchived in the data buffer 41. After the expansion, the image data undergoes necessary processing in the LCD controller 48 and is displayed on the LCD display 20 and further on the TV device 18 if the TV device 18 is connected. On the other hand, data copying between the MO cartridge 14 and the memory card 16 is handled via the bus buffer 42 under the control of the main processor 32. Further, in the simultaneous handling of the input/output processing of the host 12 from/to the USB bridge subprocessor 34 and the standalone operation by the main processor 32, for example, through time sharing, the input/output processing and the standalone operation are performed in turn on a command-by-command or frame data-by-frame data basis, with data temporarily buffered through the data transfer to the data buffer 41 of the SDRAM 40 during the processing by one processor while the other processor is active. This renders inconspicuous the overtime, if any, caused by a pause resulting from time sharing.

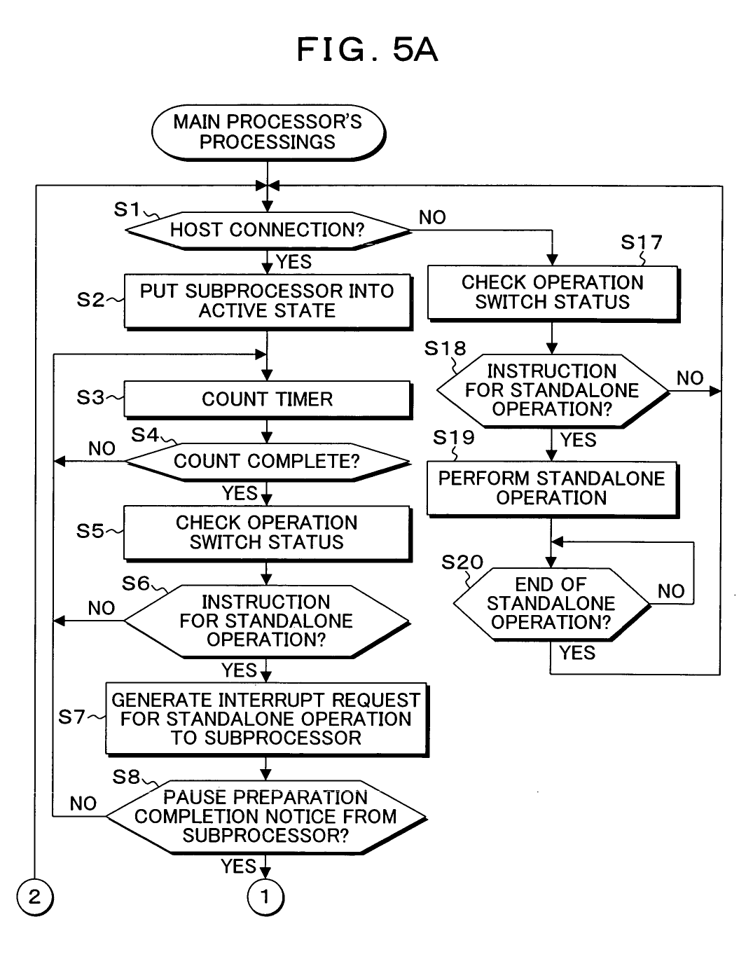

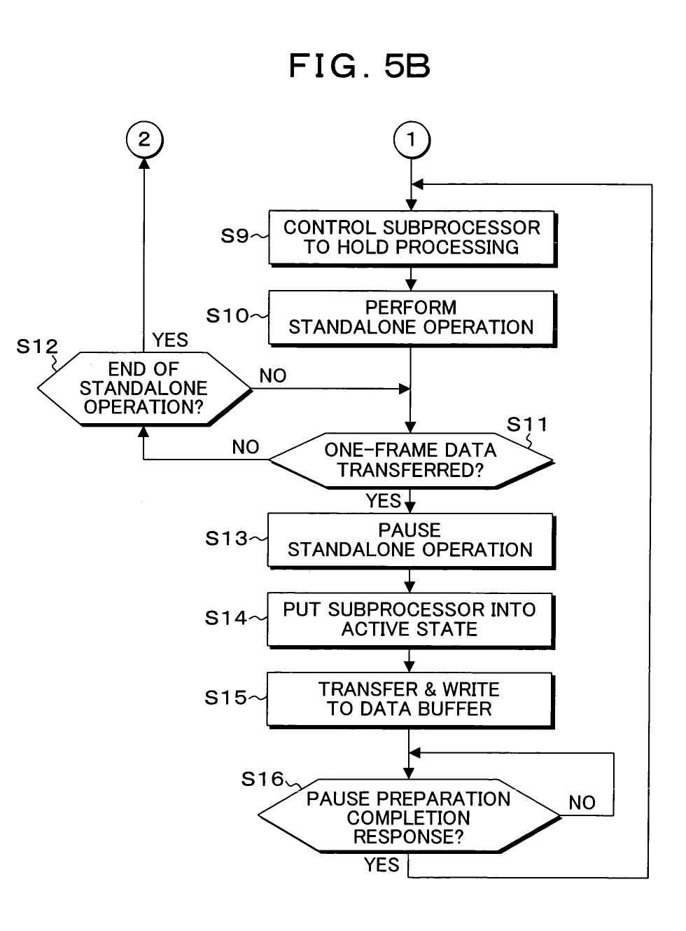

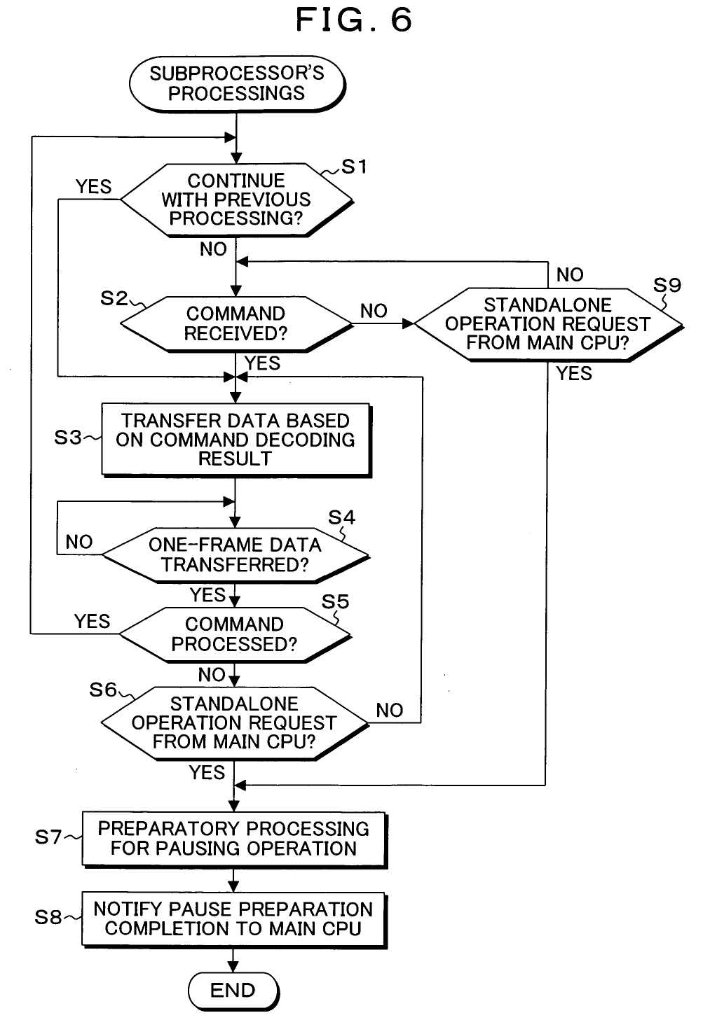

FIGS. 5A and 5B are a flowchart of the control processings by the main processor 32 in FIG. 4 that start up with the priority to the host connection mode. In FIGS. 5A and 5B, the main processor 32 checks for connection of the host 12 to the information processing apparatus 10 in step S1. In the presence of the host connection, the main processor 32 proceeds to step S2 to put the USB bridge subprocessor 34 into an active state. More specifically, the main processor 32 turns on the FET switch 60 to pull up the data signal line D+ of the USB bus 62 via the pull-up resistor 64, thus allowing the host 12 to detect the connection of the information processing apparatus 10 as a USB device and enabling the input/output processing based on the issuance of a command from the host 12. The flowchart of the subprocessor processings in FIG. 6 shows the input/output processing based on the issuance of a command from the host 12 by the USB bridge subprocessor 34. Having rendered the USB bridge subprocessor 34 active in step S2, the main processor 32 starts a timer count of a given time in step S3. When judging the count to be complete in step S4, the main processor 32 proceeds to step S5 to check the status of the operation switches provided on the operation unit 22. At this time, if a standalone operation instruction—an instruction based on operations of the operation switches—is judged to be present in step S6, the main processor 32 proceeds to step S7 to generate an interrupt request for the standalone operation to the USB bridge subprocessor 34. After receiving the interrupt request for the standalone operation from the main processor 32, the USB bridge subprocessor 34 sends a response, at the completion of a pause preparation that allows pausing the input/output processing, to the effect that the pause preparation is complete. Then, when judging a pause preparation completion notice from the USB bridge subprocessor to be present in step S8, the main processor 32 proceeds to step S9 to execute the control to hold the processing by the USB bridge subprocessor, thus temporarily halting the processing. This control is achieved as the connection with the upper-level host 12 is put on hold without disconnecting the USB bridge subprocessor from the host 12, thereby bringing about a condition of halted input/output processing. Next in step S10, the main processor 32 performs the processing in the standalone operation mode based on the processing request from the operation switches at this moment, more specifically, the main processor 32 transfers data between the MO cartridge 14 and the memory card 16 for copying or reads the image data in the MO cartridge 14 or the memory card 16 and then expands and transfers the data for display on the LCD display 20 and/or on the TV device 18. While the data transfer in the standalone operation mode is in progress, if an instruction is issued to terminate the standalone operation in step S12 before the main processor 32 judges the data transfer to be complete, then the main processor 32 terminates the processing and returns to step S1. When judging the one-frame data transfer to be complete in step S11 in the absence of an instruction to terminate the standalone operation, the main processor 32 proceeds to step S13 to pause the standalone operation and then puts the USB bridge subprocessor into an active state in step S14. That is, the main processor 32 resumes the processing that has been put on hold, continuing with the input/output processing resulting from the issuance of a command. This renders the USB bridge subprocessor 34 active once again, enabling the input/output processing based on the issuance of a command from the host 12. While the standalone operation is paused with the USB bridge subprocessor 34 in an active state, the main processor 32 transfers and writes image data to the data buffer 41 of the SDRAM 40 and, if necessary, expands the compressed data in step S15, for example, in the case of the display of the image data from the MO cartridge 14. On the other hand, the active USB bridge subprocessor 34 terminates the input/output processing from/to the host 12 and returns a pause preparation completion response when the transfer of one-frame data is complete in the data transfer based on a command from the host 12, on condition that the standalone operation of the main processor 32 is paused. For this reason, when judging the pause preparation completion response to be present from the USB bridge subprocessor 34 in step S16, the main processor 32 returns to step S9 to execute the control to hold the processing by the USB bridge subprocessor and then resumes the standalone operation again in step S10. This results in alternate repetitions of the standalone operation by the main processor 32 on a frame data-by-frame data basis and the input/output processing from/to the USB bridge subprocessor 34 by the host 12 on a frame data-by-frame data basis. Then, when judging the standalone operation to be complete after the completion thereof, the main processor 32 returns to step S1. In the absence of the host connection in step S1, on the other hand, the main processor 32 proceeds to step S17 to check the status of the operation switches and proceeds, in the presence of a standalone operation instruction in step S18, to step S19 to execute the standalone operation. Then, when the standalone operation is complete in step S20, the main processor 32 returns to step S1 to wait for the host connection.

FIG. 6 is a flowchart of the processing operations by the USB bridge subprocessor 34 performed under the control of the main processor in FIGS. 5A and 5B. In FIG. 6, the subprocessor checks whether to continue with the previous processing in step S1 and proceeds, if not, to step S2 to check for a received command. In the presence of a received command, the subprocessor 34 proceeds to step S3 to execute the data transfer for a write or read operation based on the command decoding result. Then, the subprocessor 34 checks whether the one-frame data transfer is complete in step S4, and proceeds, when judging the one-frame data transfer to be complete, to step S5 to check whether the command processing is complete. When the command processing is not complete, the subprocessor 34 proceeds to step S6 to check for a standalone operation request (interrupt request) from the main processor 32. In the absence of a standalone operation request, the subprocessor 34 returns to step S3 to execute the data transfer of one-frame data based on the decoding result of the command received at this moment. When judging a standalone operation request from the main processor 32 to be present in step S6, the subprocessor 34 proceeds to step S7 to execute the preparatory processing to pause the input/output processing operation from/to the host 12 and then notifies the pause preparation completion to the main processor 32 as a response in step S8. Upon receiving the pause preparation completion notice from the USB bridge subprocessor 34, the main processor 32 performs the control to hold the processing by the USB bridge subprocessor 34 as in step S9 of the processings by the main processor in FIGS. 5A and 5B, thus temporarily halting the processing. This is achieved as the connection with the upper-level host is put on hold without disconnecting USB bridge subprocessor 34 from the host, thereby bringing about a condition of halted input/output processing. In the absence of a received command from the host, on the other hand, the USB bridge subprocessor 34 proceeds to step S9 to check for a standalone operation request from the main processor 32 and similarly proceeds, in the presence of a standalone operation request, to step S7 to prepare to pause the input/output processing operation from/to the host 12 first and then notifies the pause preparation completion to the main processor 32 in step S8. In the second and onward subprocessor processings with the USB bridge subprocessor 34 put into an active state again under the control of the main processor 32 after the USB bridge subprocessor 34 has come to a halt as a result of completion of the first one-frame data transfer, on the other hand, the subprocessor checks whether to continue with the previous processing in step S1 and proceeds, in this case, to step S3 to resume the data transfer, currently incomplete, based on the decoding result of the command under execution. When judging the one-frame data transfer to be complete in step S4, the subprocessor proceeds to step S6 on condition that the command processing is not complete. When judging a standalone operation request from the main processor 32 to be present in step S6, the subprocessor performs the preparatory processing to halt the operation in step S7 and notifies the pause preparation completion to the main processor 32 in step S8, thus pausing the input/output processing. The processings by the main processor and the subprocessor in FIGS. 5A and 5B and FIG. 6 allow the information processing apparatus 10 of the present invention to realize the input/output processing from/to the host 12, the standalone operation of the apparatus and further both the input/output processing and the standalone operation at the same time.

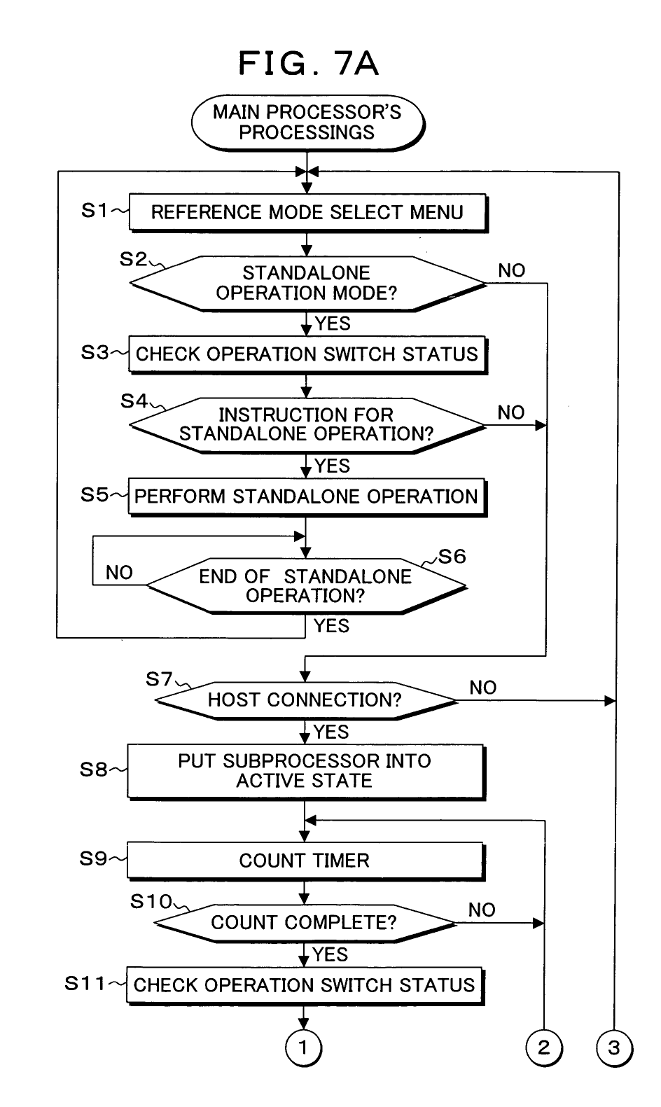

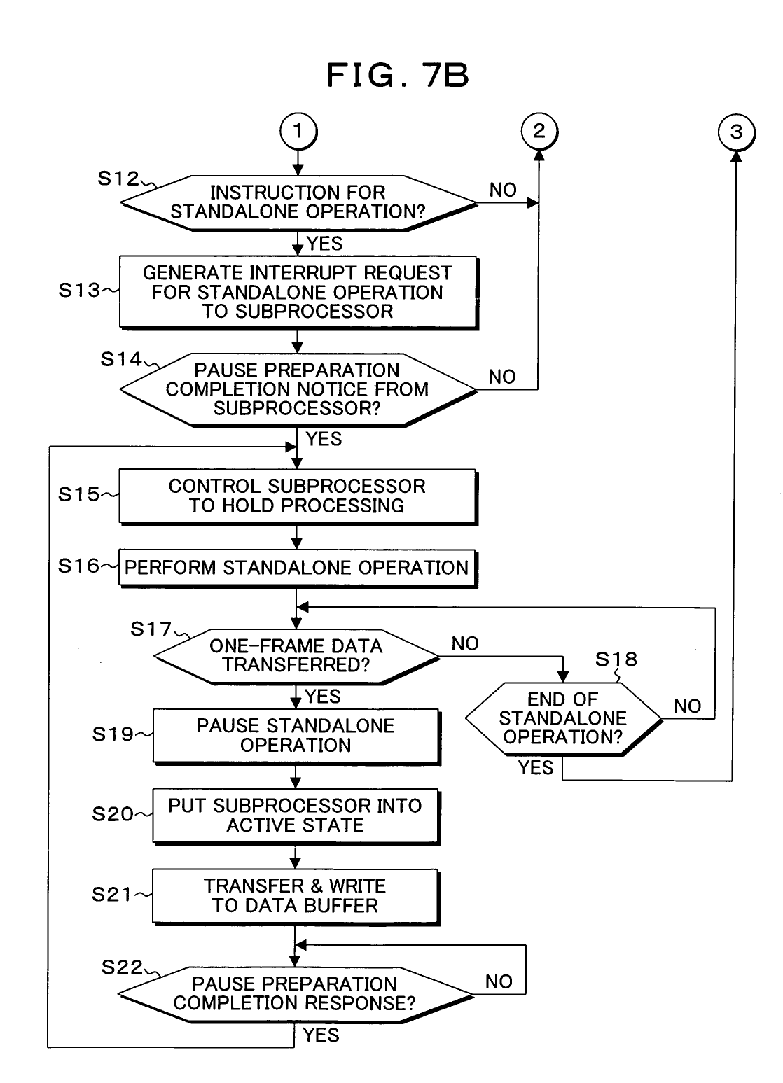

FIGS. 7A and 7B are a flowchart of the control processings by the main processor in FIG. 4 that start up in a user-selected mode at the power-up of the information processing apparatus 10 in FIG. 4. In FIGS. 7A and 7B, when the apparatus is powered up, the main processor 32 first checks the mode select menu in step S1 and judges, in step S2, the standalone operation mode to be selected when this mode is selected by the user. In step S3, the main processor 32 checks the status of the operation switches and performs, in the presence of a standalone operation instruction in step S4, the standalone operation in step S5. When the standalone operation is complete in step S6, the main processor 32 returns to step S1. As far as these processings from steps S2 to S6 in the user-selected standalone operation mode are concerned, only the standalone operation is performed. On the other hand, when the host connection mode is selected in the mode select menu in step S1, the main processor 32 proceeds from step S2 to step S7 to check for the host connection and puts, in the presence of the host connection, the USB bridge subprocessor 34 into an active state in step S8. That is, the main processor 32 turns on the FET switch 60 to pull up the data signal line d+, thus allowing the host 12 to detect the connection of the information processing apparatus 10 as a USB device and allowing the USB bridge subprocessor 34 to execute the same subprocessor processings as shown in FIG. 6, i.e., the input/output processing based on a command from the host 12. While the input/output processing from/to the host 12 is in progress by the USB bridge subprocessor 34, the main processor 32 starts a timer count in step S9 and, when judging the count to be complete in step S10, the main processor 32 checks the status of the operation switches in step S11. In the presence of a standalone operation instruction in step S12, the main processor 32 generates an interrupt request for the standalone operation to the USB bridge subprocessor 34 in step S13. When judging a pause preparation completion notice—a notice sent from the USB bridge subprocessor in response to the request—to be present in step S14, the main processor 32 performs the control to hold the processing by the USB bridge subprocessor 34 in step S15, executing the standalone operation in step S16. This standalone operation continues until the one-frame data transfer is complete in step S17. When the one-frame data transfer is complete, the main processor 32 pauses the standalone operation in step S19 and, after putting the subprocessor into an active state in step S20, transfers and writes data to the data buffer pausing from the standalone operation in step S21. Further, in the presence of a pause preparation completion notice from the USB bridge subprocessor 34 in step S22, the main processor 32 returns to step S15 again to halt the subprocessor first and then performs the standalone operation again in step S16. The main processor 32 repeats these steps until the termination of the standalone operation is confirmed in step S18. These processings from steps S7 to S22 performed when the user selects the host connection mode are the same as those from steps S1 to S16 that start up with the priority to the host connection mode. As for the processings by the subprocessor as a result of the processings by the main processor with the priority to the user selection in FIGS. 7A and 7B, these processings are the same as those from steps S1 to S9 in FIG. 6.

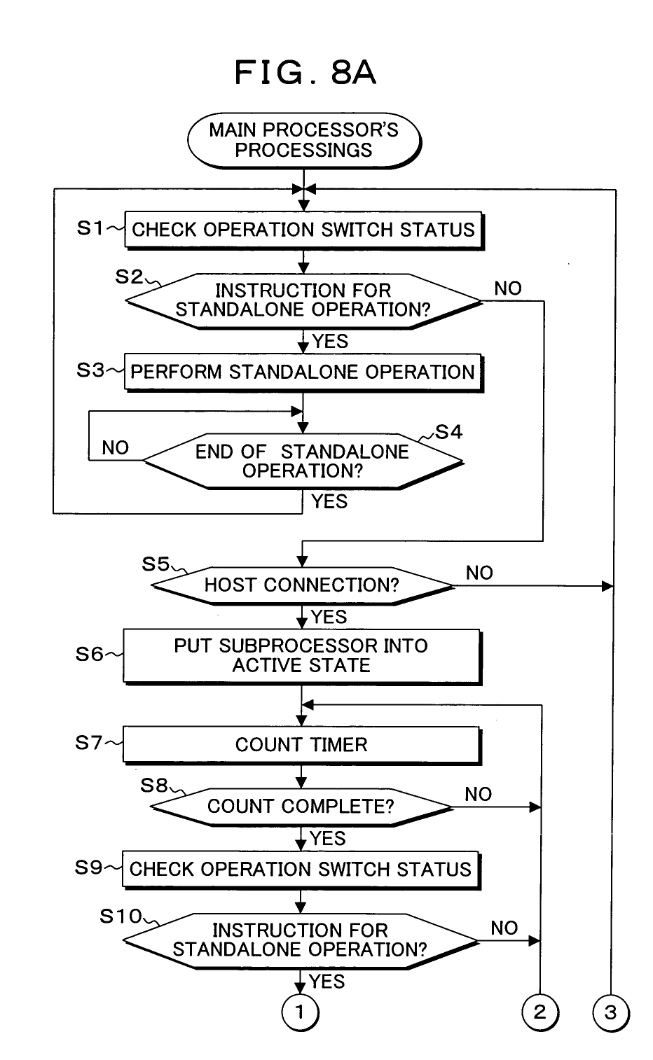

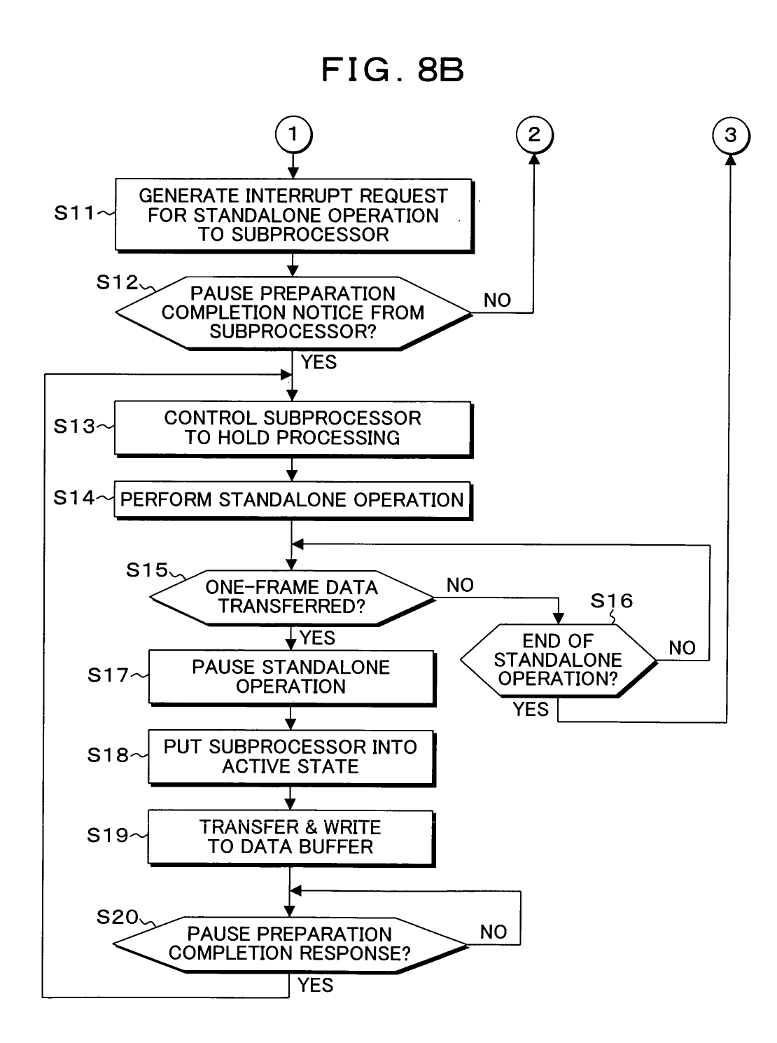

FIGS. 8A and 8B are a flowchart of the control processings by the main processor 32 in FIG. 4 that start up with the priority to the standalone operation mode at the power-up of the information processing apparatus 10 in FIG. 4. In these processings by the main processor, the main processor 32 checks the status of the operation switches at the startup by the power-up in step Si and proceeds, in the presence of a standalone operation instruction in step S2, to step S3 to execute the standalone operation. Then, when the standalone operation is complete in step S4, the main processor 32 returns to step S1. In the absence of a standalone operation instruction in step S2, on the other hand, the main processor 32 proceeds to step S5 to check for the host connection and performs the processings from steps S6 to S20 in the presence of the host connection. These processings from steps S5 to S20 in the presence of the host connection are the same as those from steps S1 to S16 with the priority to the host connection mode in FIGS. 5A and 5B. As for the processings by the subprocessor as a result of the processings by the main processor that start up with the priority to the standalone operation in FIGS. 8A and 8B, these processings are the same as those in the flowchart of FIG. 6.

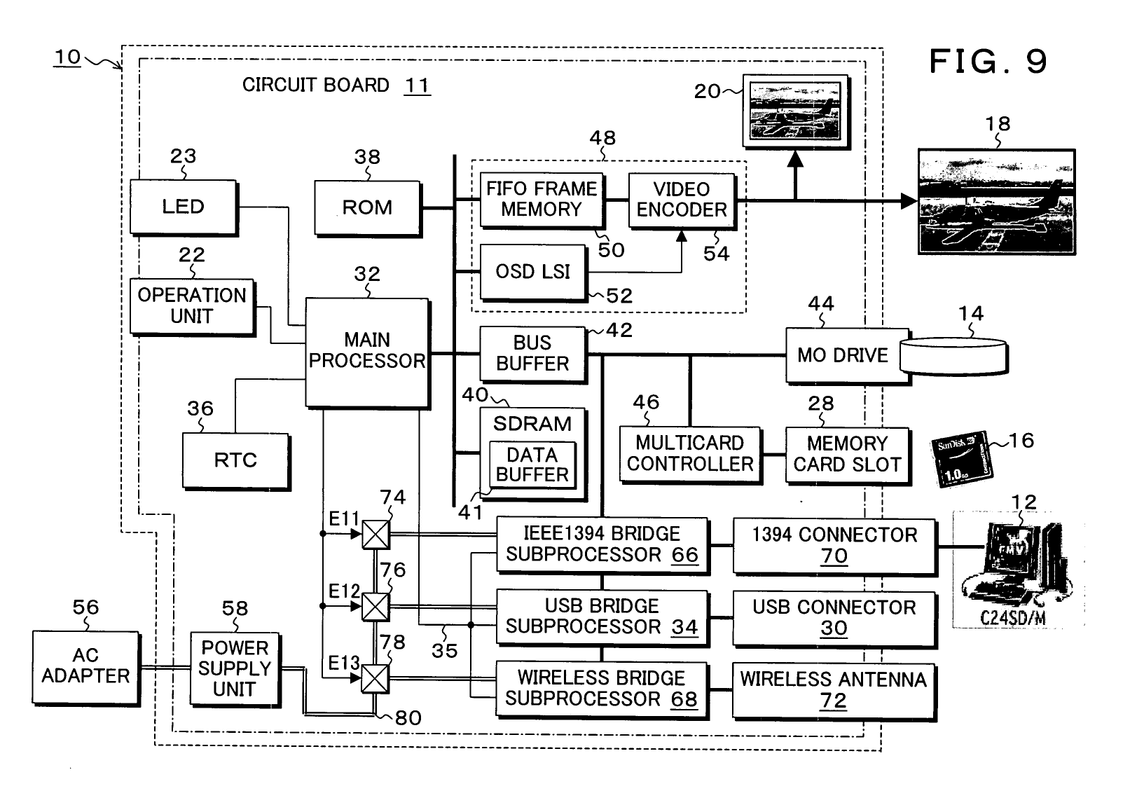

FIG. 9 is a block diagram showing other embodiment of the present invention for controlling the operating condition of a plurality of interface control subprocessors by turning the power on/off. In the present embodiment of FIG. 9, a total of three subprocessors are provided as interface control subprocessors, i.e., interface control LSIs—an IEEE1394 bridge subprocessor 66 and a wireless bridge subprocessor 68 in addition to the USB bridge subprocessor 34—with a USB connector 30, a IEEE1394 connector 70 and a wireless antenna 72 provided for the respective subprocessors. The main processor 32 monitors and controls the apparatus as a whole including these three subprocessors 34, 66 and 68. The present embodiment turns power supply to the subprocessors 34, 66 and 68 on/off to control the operating condition of the subprocessors for the input/output processing from/to the host 12 and render the subprocessors inactive at the time of the standalone operation by the main processor 32. That is, FET switches 74, 76 and 78 are provided midway along the power supply lines to the respective subprocessors 34, 66 and 68, thus allowing on/off control using control signals E11, E12 and E13 from the main processor 32. Each of the subprocessors 34, 66 and 68 and the main processor 32 are connected with a control line 35 so as to allow mutual exchange of requests and responses. In the present embodiment, the host 12 is connected to the IEEE1394 connector 70. The main processor 32 recognizes the connection of the host 12 to the IEEE1394 connector 70 and turns on the FET switch 74 with the control signal E11 at the time of the operation in the host connection mode, supplying power to the IEEE1394 bridge subprocessor 66 from the power supply unit 58 and rendering this subprocessor active. This allows the IEEE1394 bridge subprocessor 66 to execute the input/output processing by the issuance of a command from the host 12. In this manner, the main processor 32 turns power supply to the subprocessor on and off to render the subprocessor active and inactive. The present embodiment is basically the same as the embodiment in FIG. 4 except in this regard. Therefore, the processings by the main processor 32 are those in FIGS. 5A and 5B, FIGS. 7A and 7B or FIGS. 8A and 8B, whereas the processings by the subprocessors 34, 66 and 68 are the same in content as those in FIG. 6 although differing in interface control type.

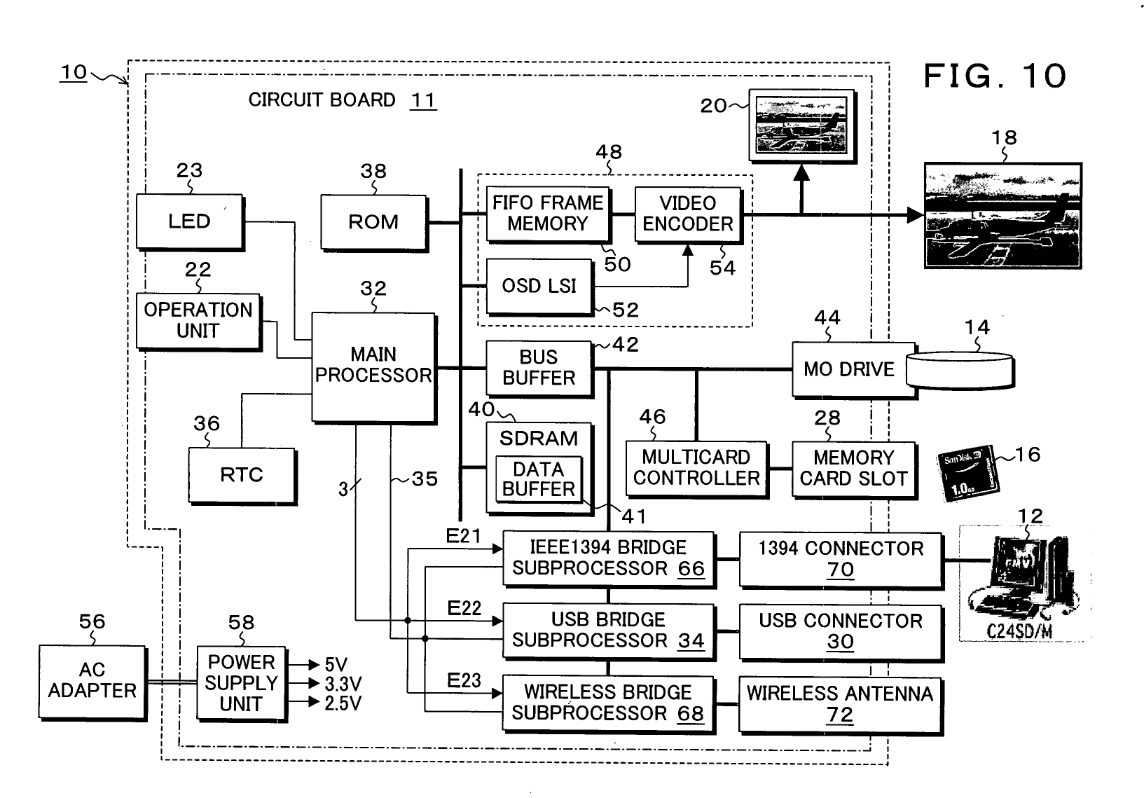

FIG. 10 is a block diagram showing other embodiment of the present invention for controlling the operating condition of a plurality of interface control subprocessors with reset signals. In the present embodiment of FIG. 10 as in the embodiment of FIG. 9, three subprocessors are provided as interface control subprocessors; the IEEE1394 bridge subprocessor 66, the USB bridge subprocessor 34 and the wireless bridge subprocessor 68, with the control line 35 used for connection to the main processor 32. The operating condition of the subprocessors 34, 66 and 68 is controlled with reset signals E21, E22 and E23 from the main processor 32. That is, the subprocessors 34, 66 and 68 can be rendered inactive as the reset signals E21, E22 and E23 are turned on. On the other hand, the subprocessors 34, 66 and 68 can be put into an active state as the reset signals E21, E22 and E23 are turned off. Controlling the operating condition of the subprocessors 34, 66 and 68 with the reset signals E21, E22 and E23 ensures a faster switching of the subprocessors as compared with the power supply on/off control in FIG. 9 because turning the reset signals on and off switches the subprocessors 34, 66 and 68—constantly powered and therefore active—between active and inactive in FIG. 10. This fast switching holds true for the control of the operating condition of the constantly powered USB bridge subprocessor 34 in the embodiment of FIG. 4. The processings by the main processor 32 in FIG. 10 are those in FIGS. 5A and 5B, FIGS. 7A and 7B or FIGS. 8A and 8B. The processings by the subprocessors 34, 66 and 68 are basically the same as those in FIG. 6.

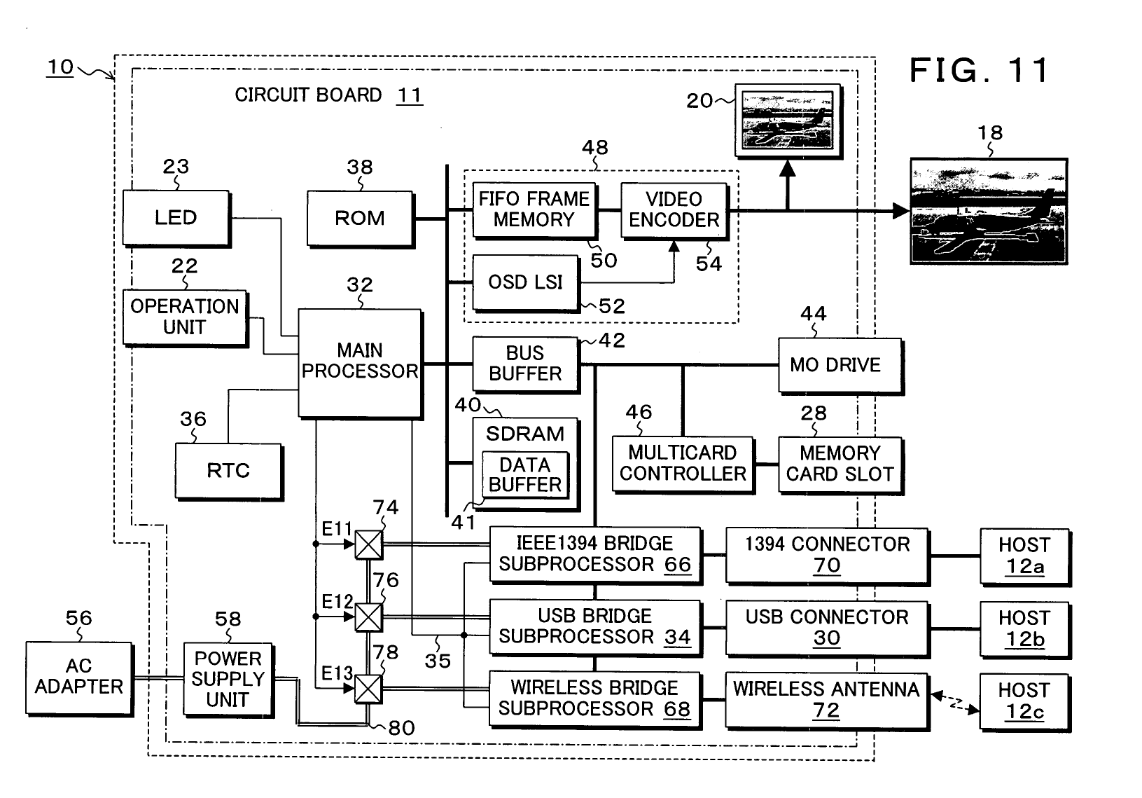

FIG. 11 is a block diagram showing other embodiment of the present invention having a multi-host connection configuration with a host connected to each of a plurality of interface control subprocessors. In the information processing apparatus 10 of the present embodiment of FIG. 11 as in the embodiment of FIG. 9, three subprocessors are provided as interface control subprocessors, namely, the IEEE1394 bridge subprocessor 66, the USB bridge subprocessor 34 and the wireless bridge subprocessor 68, with the operating condition of the subprocessors 34, 66 and 68 controlled by turning power supply from the power supply unit 58 on/off as a result of turning the FET switches 74, 76 and 78 on/off with the control signals E11, E12 and E13 from the main processor 32. As for the subprocessors 34, 66 and 68, a host 12a is connected by the IEEE1394 connector 70, a host 12b by the USB connector 30 and further a host 12c, equipped with wireless capabilities, by a wireless line using the wireless antenna 72. In the information processing apparatus 10 of the present embodiment multi-connected to the three hosts 12a, 12b and 12c in this manner, the sign of the standalone operation of the main processor 32 based on switch operations of the operation unit 22 is that the FET switches 74, 76 and 78 are turned off with the control signals E11, E12 and E13 from the main processor 32 to halt power supply to the subprocessors 34, 66 and 68 and render these subprocessors inactive. In contrast, when the standalone operation by the main processor 32 is terminated or paused, the FET switches 74, 76 and 78 are turned on with the control signals E11, E12 and E13. This supplies power from the power supply unit 58 and renders the subprocessors 34, 66 and 68 active. In this condition with the subprocessors 34, 66 and 68 put into an active state, although requests for the input/output processings by the issuance of commands could be made by the hosts 12a to 12c in a time-overlapped manner, if input/output requests are made by a plurality of the hosts, the input/output processings from/to the hosts 12a to 12c are performed through time sharing on a command-by-command-basis or on a frame data-by-frame data basis. The input/output processings from/to a plurality of hosts through time sharing can be accomplished using one of the two methods, with one method consisting of keeping the connections with the upper-level hosts constantly enabled to time-share the input/output processings and the other consisting of repeating the connection and disconnection. As for the host pausing from the processing, the data is buffered in the data buffer 41 of the SDRAM 40 to minimize the overline resulting from the paused processing. As for the time sharing between the input/output processings by the three subprocessors 34, 66 and 68 and the standalone processing by the main processor 32, the time sharing may be switched between two choices; performance of the input/output processings by the three subprocessors 34, 66 and 68 in succession following the standalone processing by the main processor 32 and alternate performance of the input/output processings by the three subprocessors 34, 66 and 68 and the standalone processings by the main processor 32. It is to be noted that while the aforementioned embodiments take, as examples of storage devices of the information processing apparatus 10, an MO drive and a memory card slot, other proper storage drives maybe provided such as an HDD (harddisk drive). While the aforementioned embodiments take, as examples of interface control subprocessors, the IEEE1394, USB and wireless subprocessors, proper interface control processors (LSIs) may be used as necessary. The present invention incorporates proper modifications without impairing the objects and advantages of the invention and is not limited to the numerical values shown in the aforementioned embodiments.

1. An information processing apparatus comprising:
a subprocessor operable to execute input/output processing from/to an upper-level apparatus; and
a main processor operable to disable a standalone operation so as to put the subprocessor into an active state when judging the upper-level apparatus to be connected, the main processor putting the subprocessor into an inactive state to allow the information processing apparatus to execute the standalone operation when judging an instruction request from an operation unit to be present.

2. The information processing apparatus of claim 1, wherein
the subprocessor executes, as the input/output processing from/to the upper-level apparatus, data transfer to write data to or read data from a storage unit based on a command from the upper-level apparatus, and wherein
the main processor executes, as the standalone operation of the information processing apparatus, tasks such as data transfer between different storage units, data transfer from the storage unit to a display unit and expansion of compressed image data for display on the display unit.

3. The information processing apparatus of claim 1, wherein
the main processor pulls up a specific signal line connecting the subprocessor and the upper-level apparatus to put the subprocessor into an active state, and wherein the main processor pulls down the specific signal line to put the subprocessor into an inactive state.

4. The information processing apparatus of claim 1, wherein
the main processor turns on power supply to the subprocessor to put the subprocessor into an active state, and wherein
the main processor turns off the power supply to put the subprocessor into an inactive state.

5. The information processing apparatus of claim 1, wherein
the main processor turns off a reset signal to the subprocessor to put the subprocessor into an active state, and wherein the main processor turns on the reset signal to put the subprocessor into an inactive state.

6. The information processing apparatus of claim 1, wherein
when recognizing the connection to the upper-level apparatus at the startup by power-up of the information processing apparatus, the main processor puts the subprocessor into an active state, and wherein
when recognizing the non-connection to the upper-level apparatus, the main processor puts the subprocessor into an inactive state to enable the standalone operation until recognizing the connection.

7. The information processing apparatus of claim 1, wherein
at the startup by power-up of the information processing apparatus, the main processor selects, based on user-set information, whether to put the subprocessor into an active state or render the subprocessor inactive to enable the standalone operation.

8. The information processing apparatus of claim 1, wherein
when judging a standalone operation instruction from the operation unit to be present at the startup by power-up of the information processing apparatus, the main processor renders the subprocessor inactive to enable the standalone operation, and wherein
when judging the standalone operation instruction to be absent at the startup by power-up of the information processing apparatus, the main processor puts the subprocessor into an active state.

9. The information processing apparatus of claim 1, wherein
when judging both a processing request from the upper-level apparatus and a processing request from the operation unit to be present, the main processor controls the subprocessor to switch between active and inactive states so as to alternately execute the processing requests from the upper-level apparatus and the operation unit through time sharing or sharing on a command-by-command basis.

10. The information processing apparatus of claim 9, wherein
at the time of alternately executing the processing request from the upper-level apparatus and the processing request from the operation unit, the main processor, while executing one of the processing requests, transfers data to a data buffer for the other processing request suspended.

11. The information processing apparatus of claim 1, further comprising a plurality of the subprocessors each operable to individually connect a plurality of the upper-level apparatuses, wherein
the main processor controls the individual subprocessors to switch between active and inactive states so as to allow the plurality of the subprocessors to execute processing requests from the plurality of the upper-level apparatuses through time sharing or sharing on a command-by-command basis.

12. An information processing method of a main processor executing a standalone operation of an information processing apparatus while at the same time monitoring a subprocessor that executes input/output processing from/to an upper-level apparatus, the method comprising:
when the upper-level apparatus is judged to be connected thereto, disabling the standalone operation and putting the subprocessor into an active state to allow the subprocessor to execute the input/output processing from/to the upper-level apparatus; and
when a processing request from an operation unit is judged to be present, putting the subprocessor into an inactive state to allow the information processing apparatus to perform the standalone operation.

13. The information processing method of claim 12, wherein
the main processor causes the subprocessor to perform, as the input/output processing from/to the upper-level apparatus, data transfer to write data to or read data from a storage unit based on a command from the upper-level apparatus, and wherein
the main processor executes, as the standalone operation of the information processing apparatus, tasks such as data transfer between different storage units, data transfer from the storage unit to a display unit and expansion of compressed image data for display on the display unit.

14. The information processing method of claim 12, wherein
the main processor turns on power supply to the subprocessor to put the subprocessor into an active state, and wherein
the main processor turns off the power supply to put the subprocessor into an inactive state.

15. The information processing method of claim 12, wherein
the main processor turns off a reset signal to the subprocessor to put the subprocessor into an active state, and wherein the main processor turns on the reset signal to put the subprocessor into an inactive state.

16. The information processing method of claim 12, wherein
the main processor pulls up a specific signal line connecting the subprocessor and the upper-level apparatus to put the subprocessor into an active state, and wherein the main processor pulls down the specific signal line to put the subprocessor into an inactive state.

17. The information processing method of claim 12, wherein
when recognizing the connection to the upper-level apparatus at the startup by power-up of the information processing apparatus, the main processor puts the subprocessor into an active state, and wherein
when recognizing the non-connection to the upper-level apparatus, the main processor puts the subprocessor into an inactive state to enable the standalone operation until recognizing the connection.

18. The information processing method of claim 12, wherein
at the startup by power-up of the information processing apparatus, the main processor selects, based on user-set information, whether to put the subprocessor into an active state or render the subprocessor inactive to enable the standalone operation.

19. The information processing method of claim 12, wherein
when judging a standalone operation instruction from the operation unit to be present at the startup by power-up of the information processing apparatus, the main processor renders the subprocessor inactive to enable the standalone operation, and wherein
when judging the standalone operation instruction to be absent at the startup by power-up of the information processing apparatus, the main processor puts the subprocessor into an active state.

20. The information processing method of claim 12, wherein
when duplicately making a processing request from the upper-level apparatus and a processing request from the operation unit, the main processor controls the subprocessor to switch between active and inactive states so as to alternately execute the processing requests from the upper-level apparatus and the operation unit through time sharing or sharing on a command-by-command basis.

21. The information processing method of claim 12, wherein
at the time of alternately executing the processing request from the upper-level apparatus and the processing request from the operation unit, the main processor, while executing one of the processing requests, transfers data to a data buffer for the other processing request suspended.

22. The information processing method of claim 12, wherein
a plurality of the subprocessors are provided each operable to individually connect a plurality of the upper-level apparatuses, wherein
the main processor controls the individual subprocessors to switch between active and inactive states so as to allow the plurality of the subprocessors to execute processing requests from the plurality of the upper-level apparatuses through time sharing or sharing on a command-by-command basis.
